(19) United States
(12) Patent Application Publication
(10) Pub. No.: US 2004/0154854 A1
(43) Pub. Date: Aug. 12, 2004

(54) Wee-kart

(76) Inventor: William C. Stephens, Hartsville, SC (US)

Correspondence Address: Jeffrey K. Seto, 406 Riverland Dr., Salem, VA, 24153, US

(21) Appl. No.: 10/724,658

(22) Filed: Dec. 1, 2003

Related U.S. Application Data
(60) Provisional application No. 60/429,994, filed on Nov. 29, 2002.

(51) Int. Cl. B60K 7/00

(52) U.S. Cl. 180/291

(57) ABSTRACT

A training go-cart that includes multiple safety features making the cart safe for operation by young children. Each axle of the Wee-Kart has two left tire and two right tires. This double wheel feature adds stability and traction to the cart. To keep potentially dangerous moving parts away from the driver, the engine is placed front of the vehicle and the drive system is housed underneath of the vehicle. The vehicle also includes at least one emergency shut off switch, which is capable of shutting off the motor. A pressure sensitive switch can be provided in the driver's seat so that the motor shuts off whenever the driver gets out of the seat. The emergency shut off switch can also be operated by a radio signal, such as a “kill” signal sent from a remote transmitter held by a parent of the driver.

This application was originally filed as U.S. provisional Patent Application No. 60/429,994 on Nov. 29, 2002 and priority is claimed to this earlier filed application.

### BACKGROUND OF THE INVENTION

The present invention relates generally to the field of motorized go-carts and more specifically to a go-cart designed with multiple safety features so that small children can safely learn how to drive a go-cart.

Go-carts are wildly popular with children, teenagers and adults. These small motorized vehicles are available in many different sizes, which make them attractive to young children and to adults. The largest go-carts are referred to as dune buggies and are used in races that extend up to one thousand miles. The most common go-carts are found in go-cart tracks that can be found in most cities and towns across the country. These common go-carts usually have a small internal combustion engine positioned in the back of the cart that provides power to one or more of the carts four tires. These traditional go-carts are primarily for use by teenagers and adults, as their operation is inherently dangerous. These go-carts can reach high speeds and are capable of tipping over, leading to serious injuries.

In spite of the risks involved with operating go-carts, driving a go-cart is pure fun and many people will continue to enjoy this sport. What is needed in the field is a training go-cart that is safe enough for young children to drive. Such a training cart would teach young children the skills necessary to safely operate larger traditional carts.

### SUMMARY OF THE INVENTION

A motorized vehicle with multiple safety features that make the vehicle safe for operation by young drivers including children. The vehicle comprises a frame that is attached to a front axle and a rear axle. The front axle is mechanically connected to four front tires and the rear axle is mechanically connected to four rear tires, with each axle having two left tires and two right tires. Fenders are provided for covering the four tires closest to the driver. The motor is located in the front of the vehicle and includes at least one electronic circuit that must be in a closed position in order for the motor to operate. The transmission is located in the rear of the vehicle and is connected to the motor by a drive belt that extends underneath of the vehicle from the front to rear of the vehicle. The driver's seat is located in the middle of the vehicle, for optimal balance, and includes a seat belt that is capable of securing the driver to the seat. The floor of the vehicle extends across the middle of the vehicle and separates the driver from the drive belt and other moving parts underneath of the vehicle.

The vehicle does not have a traditional throttle. Rather the gas pedal is used to engage the transmission, when pressure is exhorted on the gas pedal. When no pressure is exhorted on the gas pedal, the transmission is disengaged and the vehicle acts as if it were in neutral. The speed of the vehicle does not increase if additional pressure is exhorted on the gas pedal. The brake pedal is mechanically connected to a braking system that is capable of slowing the vehicle to a stop. The steering wheel is mechanically connected to a steering assembly that is capable of steering the vehicle.

The vehicle also includes at least one device that is capable of opening the electric circuit in the motor, thereby shutting off the motor. The device can be a pressure sensitive switch that is located in the seat, wherein the motor will only operate when the driver is in the driver's seat. The device may also include a radio receiver that is capable of receiving a radio “kill” signal from a source outside of the vehicle that causes the motor to shut down.

It is an object of the present invention to provide a training go-cart with multiple safety features that make the cart safe for operation by children.

### BRIEF DESCRIPTION OF THE DRAWINGS

The invention of the present application will now be described in more detail with reference to the accompanying drawings, given only by way of example, in which:

FIG. 1 is a perspective view of the preferred embodiment of the present Wee Kart;

FIG. 2 is a side view of one embodiment of the present Kart;

FIG. 3 is a bottom view of the preferred embodiment;

FIG. 4 is a back view of one embodiment;

FIG. 5 shows the attachment assembly for one of the front sets of tires; and,

FIG. 6 shows the operation of the steering assembly.

### DETAILED DESCRIPTION OF THE INVENTION

The present invention is a training Go Cart, called a Wee Kart, that teaches small children the skills necessary to ride a standard-sized Go Cart. Aside from its training function, it also instructs proper safety methods to children while providing them with a fun activity.

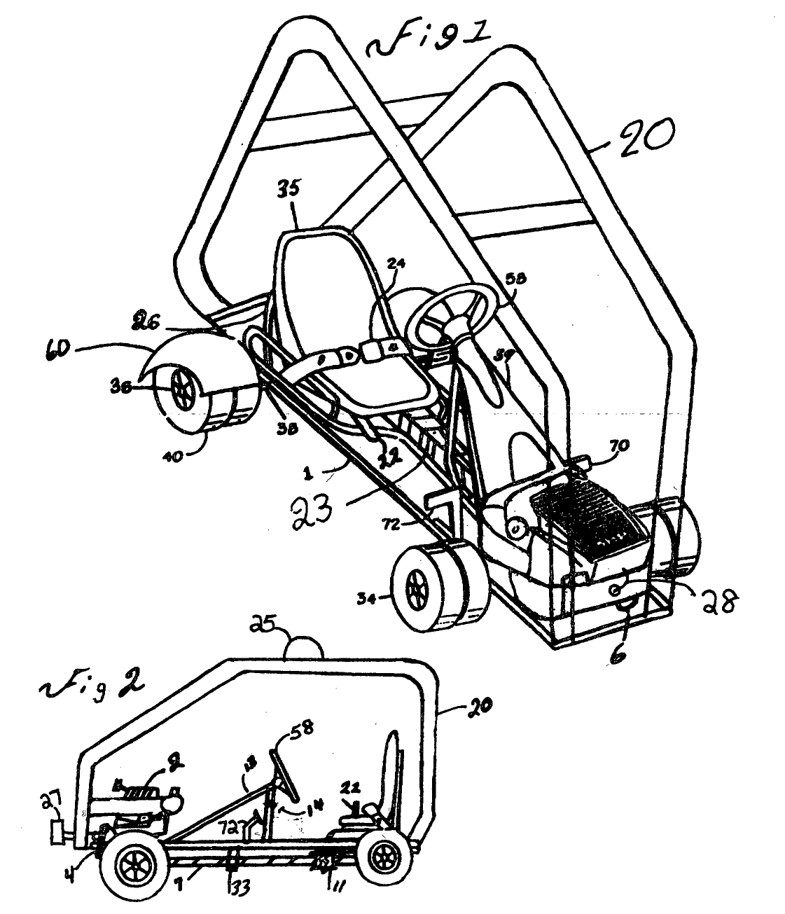

Referring to FIG. 1, the Wee Kart has a double-wheel safety feature that provides for stableness and added traction. The double wheels 34 & 40 also permit the Kart to roll in sand, on gravel, over twigs and small bumps, and other terrain. Steering on the Wee Kart is also improved by this double-wheel feature. In the preferred embodiment, the front two wheels 34 are independent of each other, and the back wheels 40 are bolted together, by rear wheel assembly 36, for better traction. The two sets of back wheels are connected by rear axle 38. As children are the intended drivers of the Wee Kart, the Kart has been designed with many safety features. The engine of the Kart is mounted in the front, and all moving parts of the Kart are positioned underneath of the Kart. The drive belt of the Kart is housed underneath of belt cover 23. This purposefully design of the Kart prevents hair and clothing of children from being caught in any moving parts. By placing the engine in the front of the Kart, the chain mechanism and other hazardous conditions are removed. Further, the engine can be preset from the manufacturer with a governed speed of 7 mph, and the Kart can be provided without a throttle control. Lacking a throttle control prevents an older child, for example, from increasing the maximum speed of the Kart through a simple mechanical adjustment. In order for the Kart to go faster than the preset 7 mph, a parent would have to take the Kart to a service center where the speed could be increased to 15 mph. Given the unique positioning of the engine, the child driver also is prevented from starting the Kart by himself or herself. Since the engine is by far the most dangerous part of the Kart, and contains the most moving parts, the engine is positioned farthest away from the child driver.

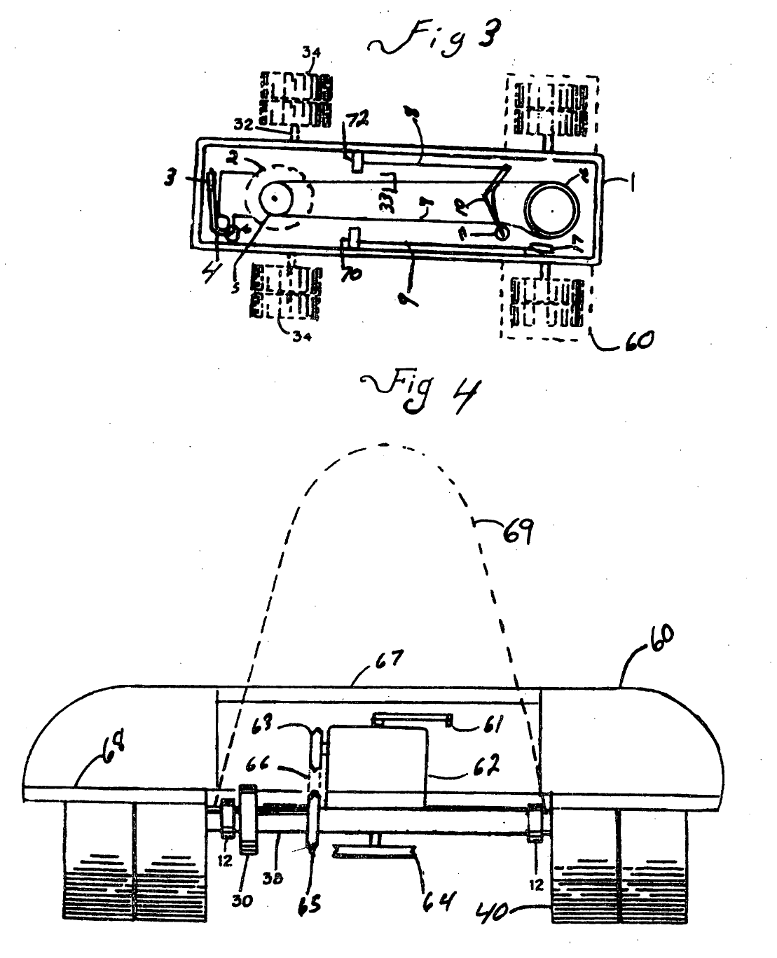

A chasis, or frame, 1 supports the driver's seat 35, the engine and transmission. The frame 1 is also attached to the rear axle 38 and front axle 32 (shown in FIG. 3). A steering wheel 58 and steering wheel assembly 59 are used to steer the Kart. Gas pedal 72 and brake pedal 70 are used to start and stop the Kart, respectively.

Further contributing to the overall safety of the Kart is a “kill” switch 22 that is placed under the child's seat 35. When the child gets off of the seat 35, a necessary electrical connection in the engine is disrupted and the engine ceases running. Thus, even if a child driver gets out of the Kart without supervision, the engine automatically turns off. This “kill switch” feature is also available on the Wee Kart in two other formats, both of which take advantage of radio transmissions. First, a remote radio control can be provided to the parents of the young driver, giving the parents the ability to shut off, or kill, the engine whenever desired. An antenna 28 and radio receiver 6 on the Kart receive a “kill” signal from the parents that causes the engine to stop running. The same antenna 28 and receiver 6 can be used to enforce a boundary within which the Kart must stay within in order to keep running. If the Kart ventures outside of the boundary, then a radio signal is automatically sent to the Kart killing the engine. The driver's seat 35 is supported by seat brace 26 and includes seat belt 24, which serves the twofold purpose of protecting the child and teaching a sense of continued seat belt use. The seat 35 is positioned in the center of the Kart, allowing for maximum balance.

Fenders 60 are in place to protect children from the wheels when the Kart is in motions and when the young drivers are getting in and out of the Kart. Children are therefore unable to put their hands on the wheels or other moving parts, as all moving parts are retained under the Kart and/or shielded from the children.

Roll cage 20 protects the child drivers from the unlikely event of a roll-over and instills a sense of being safe and secure in the young drivers when seated in the present Kart. The Kart is designed specifically so that the weight is balanced when the child is seated. When the seat is empty, the lightweight of the back end of the Kart is designed so that a young mother could easily lift the backend and maneuver the Kart. The overall design of the Kart was conceptualized with safety in mind. The advantage to the child is that they can train, have fun and be safe at the same time. The child must be assisted in order to start the Kart, and parents are further comforted by the fact that the child cannot operate the Kart without assistance. The Kart is similar to a standard Go Cart, so that a child can easily make a later transition to a standard Go Cart.

FIG. 2 is a side view of the present Kart. One or more strobe lights 25 can be provided at any location on the Kart. In FIG. 2, one stobe light 25 is placed on top of the Kart. Of course, if a strobe light is placed in the line of sight of the driver, light shields will be provided to prevent the light from shining in the eyes of the driver. Another safety feature of the present training go cart is a “bump kill switch” 27. This kill switch extends out in front of the frame and roll cage 20 of the Kart and kills the engine when the vehicle bumps into another object. FIG. 2 also shows the routing of drive belt 7 underneath of the Kart, from the engine 2 to the transmission at the rear of the Kart. The steering wheel 58 is supported by steering wheel support 14, and the steering wheel is attached to steering column 13. Kill switch 22 is shown in an alternate position in this figure. Belt guide 33 keeps the belt 7 from drooping in the middle portion of the vehicle. Clutch pulley 11 is used to engage the transmission by exhorting pressure, or tension, on the belt in response to the driver pressing on the gas pedal 72. Such slip clutch assemblies are well known in the art.

FIG. 3 is a bottom view of the preferred embodiment. The muffler 3 and exhaust manifold 4 are routed from the engine 2 under the frame 1 and away from the driver; a heat shield is preferably provided. Also visible in FIG. 3 are front tires 34, front axle 32, first drive pulley 5, drive belt 7, second drive pulley 16 and the outline of fenders 60. The brake pedal 70 is connected to braking mechanism 17 by brake cable 9. The gas pedal 72, cable 8, lever 10 and wheel 11 are part of a power engagement system that selectively engages and disengages the drive belt 7 with, and from, pulley 16, which is attached to the transmission of the Kart.

FIG. 4 is a back view of an embodiment wherein the fenders 60 have been connected by body cover 67 and incorporated into a outer body of the Kart that is designed to make the Kart look like a race car. The roll cage has been incorporated into an elongated dome roof 69 in this embodiment. In other embodiments, other body covers could be used to give the present Wee Kart different looks, such as a puck-up truck and a military HUMV (Hummer). The central rear section has been cut-away to show the transmission 62 of the Kart. Power is received from the engine via second drive pulley 64. The transmission transfers this power to first transmission pulley 63, transmission belt 66 and second transmission pulley 65, which is attached to rear axle 38. Also shown in FIG. 4 are rear tires 40, attachment points 12, where the frame attached to the rear axle 38 and disk brakes 30. On top of transmission 62 is shifter 61, which allows the vehicle to operate in neutral, forwards or backwards.

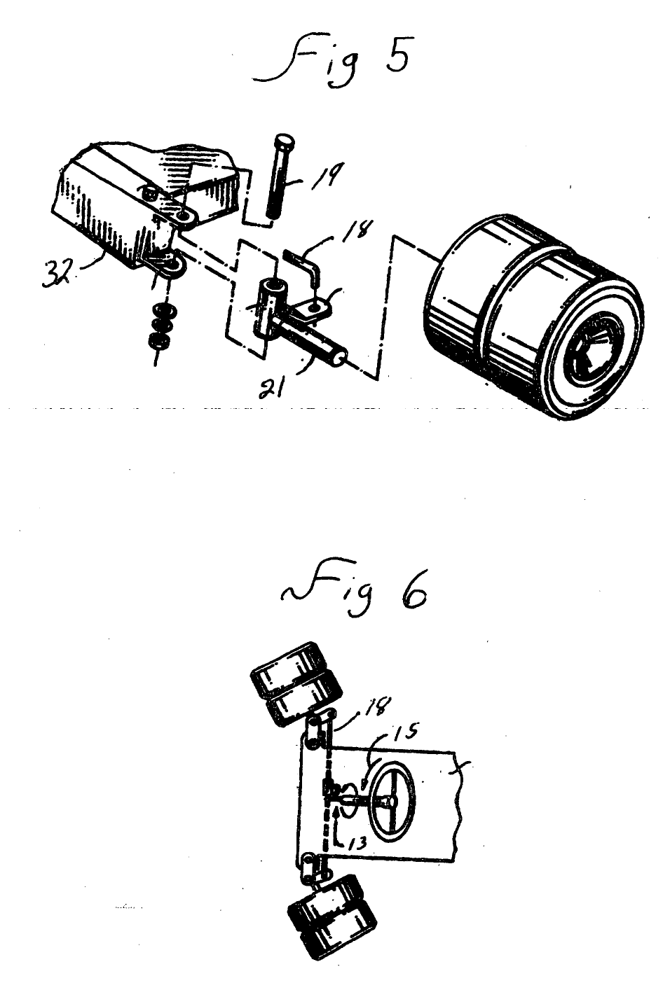

FIG. 5 shows the attachment assembly for one of the front sets of tires. The set of tires are semi-rotatively attached to the front axle 32 by steering arm 21, retaining pin 19, and steering axle 18.

FIG. 6 shows the operation of the steering wheel assembly, which includes steering column 13 and steering axle 18.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A motorized vehicle with multiple safety features that make the vehicle safe for operation by young drivers including children, the vehicle comprising:
a frame that is attached to a front axle and a rear axle, wherein the front axle is mechanically connected to four front tires and the rear axle is mechanically connected to four rear tires;
two fenders for covering the four rear tires;
a motor that is located in a front of the vehicle, the motor having at least one electronic circuit that must be in a closed position in order for the motor to operate;
a transmission that is located in a rear of the vehicle, the transmission being connected to the motor by a drive belt that extends from the front of the vehicle to rear of the vehicle and below a level of the frame;
a driver's seat that is located in a middle of the vehicle, the driver's seat including a seat belt that is capable of securing a driver to the seat;
a vehicle floor that extends across the middle of the vehicle, the vehicle floor separating the driver from the drive belt and other moving parts underneath of the vehicle;
a gas pedal that is capable of engaging the transmission, wherein the transmission is disengaged when no pressure is exhorted on the gas pedal and the transmission is engaged when pressure is exhorted on the gas pedal, and further wherein a speed of the vehicle does not increase when an additional amount of pressure is exhorted on the gas pedal;
a brake pedal that is mechanically connected to a braking system that is capable of slowing the vehicle to a stop;
a steering wheel that is mechanically connected to a steering assembly that is capable of steering the vehicle; and,
at least one device that is capable of opening the electric circuit and thereby shutting off the motor.

2. The vehicle of claim 1, further comprising a roll cage.

3. The vehicle of claim 1, wherein the device that is capable of shutting off the motor is a pressure sensitive switch that is located in the seat, the motor being able to operate when the driver is seated in the seat and the motor being shut off by the switch when the driver gets out of the seat.

4. The vehicle of claim 1, further comprising a radio receiver, wherein the radio receiver is capable of receiving a radio “kill” signal from outside of the vehicle that causes the motor to shut down.

5. The vehicle of claim 4, wherein the radio “kill” signal comes from a hand held radio transmitter.

6. The vehicle of claim 4, wherein the “kill” signal comes from one or more transmitter(s) that define a boundary within which the vehicle is supposed to stay.

7. The vehicle of claim 1, wherein the device capable of shutting of the motor off is a bump switch that is attached to the front of the vehicle, wherein when the motor if shut off when the vehicle runs into an object.

8. The vehicle of claim 1, further comprising at least one strobe light.

9. The vehicle of claim 1, wherein the braking system is a disk braking system.

10. The vehicle of claim 1, wherein the transmission includes a shift lever that can be used to shift the transmission between neutral, forward and backwards.

11. The vehicle of claim 1, further comprising a body cover that attaches to the top of the vehicle, wherein the body cover can be provided in different shapes including a formula one race car, a pick-up truck and a military hummer.

12. The vehicle of claim 1, wherein the rear axle has two left tires and two right tires and the two left tires are bolted together and the two right tires are bolted together.
